(19) United States
(12) Patent Application Publication
(10) Pub. No.: US 2001/0023159 A1
(43) Pub. Date: Sep. 20, 2001

(54) Absorbent pad

(75) Inventors: Chih-Hung Chen, Naperville, IL (US); Jack A. MacPherson, Aurora, IL (US)

Correspondence Address: THE CLOROX COMPANY, P.O. BOX 24305, OAKLAND, CA, 94623-1305, US

(73) Assignee: First Brands Corporation

(21) Appl. No.: 09/835,060

(22) Filed: Apr. 13, 2001

Related U.S. Application Data
(62) Division of application No. 08/558,057, filed on Nov. 13, 1995.

(51) Int. Cl. B32B 5/16; B32B 5/26; B32B 27/12

(52) U.S. Cl. 442/394; 428/327; 442/382

(57) ABSTRACT

An absorbent pad formed having an upper film layer of a heat resistant porous material: a lower film layer of a heat resistant, non-absorbent, non-porous material, the lower film being bonded to the upper film layer along at least two of their respective opposing peripheral edges and an intermediate absorbent layer of liquid absorbent material between the upper film layer and lower film layer having the absorbent material at least partially bonded to the inside surface of at least one of the upper film layer or lower film layer.

### BACKGROUND OF THE INVENTION

The present invention relates to absorbent pads for liquids associated with food products. More particularly, the present invention relates to absorbent pads incorporating absorbent fibers with thin film materials affixed thereto. These absorbent pads are useful in the absorption of liquids from foods and may also be used in microwave cooking or at low conventional oven temperatures.

Meat, poultry and other food products are typically associated with water, oils and greases formed as a result of their storage, handling or cooking. Consumers have become very conscientious of health benefits resulting from the removal of fats and greases. As the result of the natural occurrence of oils, greases or other liquids from such food products, it has been found that there is a need for an improved means for removing such liquids which is better than mere physical draining from a pan or container. Further, it has been found that such liquids from such food products can diminish both the taste and appearance of the food products. Furthermore, oils, greases and other liquids generally create an undesirable appearance and taste, giving the impression that the food is low quality.

Although there have been numerous developments in absorbent meat pads, these developments have centered around the use of an absorbent pad which is received in a supporting tray or bag for raw foods such as chicken and beef. Such absorbent pads do not generally absorb all the liquid and, further, the food still comes into contact with the liquids absorbed by the absorbent pad. As a result, some absorbent pads have been developed with an imperforate plastic film or non-absorptive barrier above the absorbent pad allowing side and bottom wicking of the exuded liquids, while seeking to prevent reverse migration of the liquids back into contact with the food products. An example of this type of pad is shown in U.S. Pat. No. 3,026,209. Some more recent developments have included the use of an absorbent pad sealed within upper and lower plastic films, and with one of the upper or lower films being perforated for top and/or bottom wicking of the exuded liquids by the absorbent pad therein are shown by U.S. Pat. Nos. 4,275,811; 4,321,997; 4,382,507 and 4,410,578. In general, these patents teach that perforating only one film layer, preferably the bottom film layer only, permits bottom wicking and retention of the exuded liquids or juices within the circumferentially sealed upper and lower film layers, without any reverse migration of the liquids or juices back into the food.

It has been observed that absorbent pads such as disclosed in U.S. Pat. Nos. 4,275,811; 4,321,997; 4,382,507 and 4,410,578, do not sufficiently absorb and retain liquids in certain uses and are not specifically suited for use in cooking, especially microwave cooking. For example, if the absorbent pad is exposed to pressure, the juice will be squeezed from the pad and into direct contact with the food. In. U.S. Pat. No. 4,321,997, the absorbent pad is provided with a spacing means which the patentee claims to be useful in preventing such squeezing of the liquid from the pad. A disposable foil broiling sheet is disclosed in U.S. Pat. No. 4,394,410 having a bottom aluminum layer, top layer of perforated aluminum and a middle absorbent layer. The middle layer may be smaller than the top and bottom layers.

### SUMMARY OF THE INVENTION

The present invention includes:

a new absorbent pad for absorbing liquids including oils from foods;

an absorbent pad which includes a cover layer and absorbent material to absorb and hold liquids from foods in the absorbent pads and out of contact with foods:

an absorbent pad manufactured from man made or natural fabrics or combinations thereof, and which also absorbs liquids therein, with temperature resistant protective surfaces attached thereto; and

an absorbent pad which provides top wicking for retaining liquids within the absorbent pad. The instant absorbent may be manufactured as individual components or in an elongated strip for separation into separate components or units, are relatively simple and easy to construct and manufacture, and are well adapted for the purposes intended.

In one embodiment the invention relates to an absorbent pad for absorbing liquids having;

a. an upper film layer of a heat resistant, porous (i.e., having perforations or other openings therein) material having outside and inside surfaces and four peripheral edges;

b. a lower film layer of a heat resistant, non-absorbent, non-porous material having four peripheral edges, the lower film layer having outside and inside surfaces and being bonded to the upper film layer along at least one of their respective two pairs of opposing peripheral edges; and

c. an intermediate absorbent layer of liquid absorbent material between the upper film layer and lower film layer and preferably spaced having peripheral edges recessed from said peripheral edges of said upper film layer and lower film layer and, further, optionally, at least partially bonded to the inside surface of at least one of the upper film layer or lower film layer.

### DESCRIPTION OF THE DRAWINGS

In the drawings: FIG. 1 is an exploded isometric view of three layers forming the absorbent pad of the present invention;

FIG. 2 is a view of an absorbent pad in assembled relationship and ready for use; and

FIG. 3 is a fragmentary sectional view of the assembled layer of an absorbent pad.

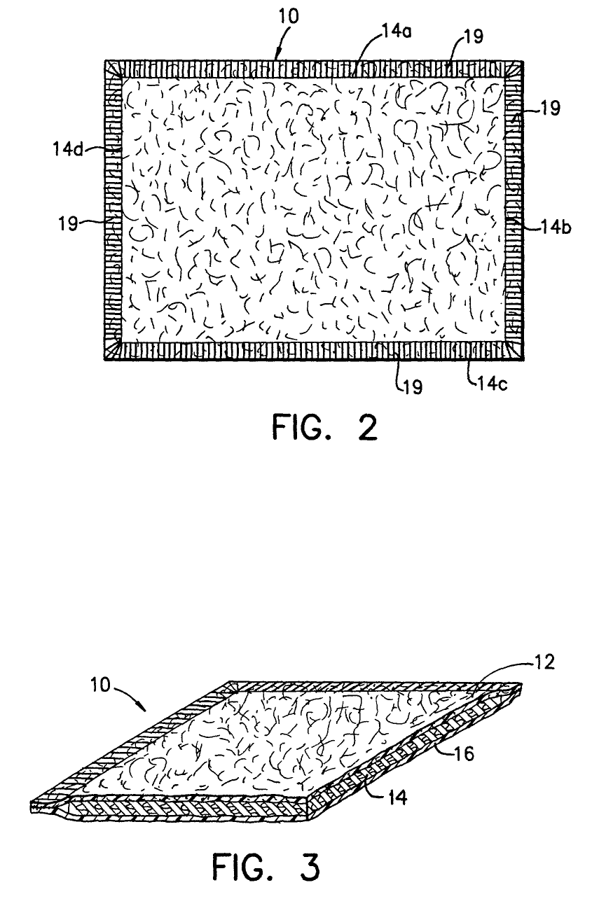

### DESCRIPTION OF THE INVENTION

Briefly stated, the instant absorbent pad includes an upper film layer and lower film layer, the upper film layer having a plurality of opening or a porous non-woven or woven structure therethrough. The upper layer is characterized as being a temperature resistant material with perforations, slits or other open pore structure (such as provided by spunbonded materials formed from plastic fiber, such as polyecarbonate, nylon, polypropolene and/or other woven or non-woven sheet materials) and said lower layer is characterized as being a non-porous temperature resistant material. An intermediate absorbent layer is positioned intermediate the upper film layer and lower film layer and is characterized as liquid absorbing material having a liquid absorbing structure throughout the absorbent layer for absorbing a wide variety of the liquids. The absorbent material is capable of absorbing and holding liquid therein while being retained and supported between the upper film layer and the lower film layer. The upper film layer and lower film layer are attached to one another along at least two of the four peripheral (or marginal) edge portions thereof to retain the intermediate absorbent layer between the upper film layer and lower film layer. In one embodiment the liquid is a liquid fat or grease from cooking or an oil from meat, poultry, fish or other food products, and the absorbent material is selected to have preferential absorbency for fats, grease and oils from meat, poultry and fish.

In one embodiment the invention relates to an absorbent pad for absorbing liquid or the like comprising:

a. an upper film layer of a heat resistant, porous material having outside and inside surfaces and four peripheral edges,

b. a lower film layer of a heat resistant, non-metallic, non-absorbent, non-porous material having four peripheral edges, the lower film layer having outside and inside surfaces and being bonded or sealed to the upper film layer along at least one of their two pairs of respective opposing peripheral edges; and

c. an intermediate absorbent layer of liquid absorbent material between the upper film layer and lower film layer and preferably having its peripheral edges recessed from said peripheral edges of said upper film layer and lower film layer and, further, optionally being, at least partially bonded to the inside surface of at least one of the upper film layer or lower film layer.

The upper film layer and lower film layer are preferably formed from heat resistant plastic materials. The absorbent material of the intermediate thermoplastic fibers and/or (spunbonded polyesters, nylons, polycarbonate and the like) absorbent layer is preferably made from as cellulosic-based absorbent materials such as wood or other pulps, papers, cotton or may be formed from other similarly functional absorbent materials. The absorbent material fibers may be made from man made or natural pulps or fibers or combinations thereof and may be of woven or non-woven material, but preferably are cellulosic-based absorbent materials derived from wood pulp. Wood pulp and paper absorbent materials are generally preferred owing to their low cost and generally high liquid absorbency. If the upper film layer and intermediate absorbent material are both made from thermoplastic fibers, the upper film layer will preferably have a lower liquid absorbency as compared to the absorbency of the intermediate absorbent layer, such that at least 90 weight percent, preferably at least 99 weight percent of the absorbed liquid is retained by the absorbency of the intermediate absorbent material. Wood pulp and paper absorbent materials may be employed and are particularly useful in absorbing the oils commonly found as byproducts during handling and the preparation of food, such as meats, poultry and fish. The absorbent material generally comprises fibers which are secured to one another as woven or non-woven structures to provide a plurality of interacting structurally supported fibers. The term “absorbent” is used herein in its broadest sense to include any liquid retention mechanism, including adsorption and chemical reactivity of the liquid with the material within or on which the liquid is retained. Cellulosic absorbents suitable for use as the absorbent material herein are available from Walkisoft USA as an air laid paper product (Product code FG413SHB) characterized as having an absorbency rate of about 0.5 second per milliliter of water and an absorbency capacity of greater than about 13 grams of water per gram of the cellulosic absorbent. A wood pulp or paper absorbent useful in this invention is characterized as having a water absorbency of at least 10 grams per gram of absorbent and a corn oil absorbency of at least 9 grams per gram of absorbent. The aforementioned absorbents are commercially available products from Walkisoft and both satisfy the above absorbency criteria.

In one embodiment the upper film layer is preferably a porous, spun non-woven material such as polyester characterized as spunbonded polyester while the lower film layer is a non-porous layer preferably a non-porous polyester characterized as a polyester film or coextruded polyester having a polyester layer and a lower melting layer for use in heat sealing the two outer layer in relation to the absorbent layer.

In one embodiment the three layers are a upper film layer of spunbonded polyester having a size 9 inches by 13 inches, the intermediate layer is an absorbent paper formed from wood pulp having a size 7.75 inches by 11.75 inches and lower film layer is a coextruded polyester film having a size 9 inches by 13 inches having a sealing layer for providing a heat seal between the upper film layer and the lower film layer along peripheral edges with the peripheral edges of the intermediate absorbed layer being recessed from the peripheral edges of the upper film layer and lower film layer.

Owing to the shape of most food preparation containers, the absorbent pad preferably has a generally rectangular shape defined by two opposing pairs of marginal edge portions (also referred to herein as “peripheral edges”) sealed at two or more by adhesive and/or heat sealing to provide a peripheral seal for the absorbent pad.

One method of constructing the instant absorbent pad includes the steps of forming the upper film layer and the lower film layer; positioning the film layers in spaced relationship to one another and respectively overlapping the absorbent material therebetween to provide a multilayer absorbent material product; positioning the absorbent layer between the upper and lower plastic film layers for sealing; moving the layers of the multilayer product into close proximity to one another for sealing; and attaching marginal edges of the upper film layer and lower film layer along two or more of the marginal edges thereof to retain the intermediate absorbent layer therebetween. The layout or form of the seals may be selected to provide bonding directly between the upper film layer and the lower film layer or may to through the three layer structure by mechanical or thermal bonding. In one embodiment the seal is a lamination mechanical seal which physically attaches the three layers by patterned pressure in the three layer structure. A variation of this embodiment is the use of an adhesive or thermally sealable layer placed on or coextruded with the lower film layer. When the lower, non-porous layer is a crystalline polyester, the adhesive layer can be a coextruded amorphous polyester which is activated by heat as a seal is made along any of the peripheral edges. Although the seal is described as being along the peripheral edges, such may also be over a portion of the entire surface of the upper film layers and lower film layer to provide additional sealing or a pattern or textured surface.

In another method, the upper film layer and lower film layer and the intermediate absorbent layer may be formed as individual absorbent pads or into an elongated absorbent pad strip, and the absorbent pad strip may be separated transversely thereof into discreet units with each unit forming an individual absorbent pad or by cutting from the strip or perforation lines may be placed between individual pads on a continuous roll of the three layer material used to form the absorbent pads as needed. In forming an elongated absorbent pad strip, the upper film layer and lower film layer are attached to one another along the two opposite continuous marginal edge portions thereof. Following transverse separation of individual absorbent pads from the elongated pad strip, the upper film layer and lower film layer may be attached along opposite separated transverse edge portions if it is elected to circumferentially seal the absorbent pad on all four peripheral edges. Alternatively, the continuous structure may be perforated therealong to facilitate separation into individual absorbent pads when sold as a roll of absorbent pads. Alternatively, the upper film layer and lower film layer may be attached to one another both along opposite continuous marginal edge portions and not attached along spaced transversely extending portions. Further, the absorbent pad strip may be separated along the spaced transversely extending portions thereof so as to form individual absorbent pads from a long sheet and provided with four peripheral seals per absorbent pad with the edges of the absorbent material recessed from the four sealed peripheral edges of the upper film layer and tower film layer.

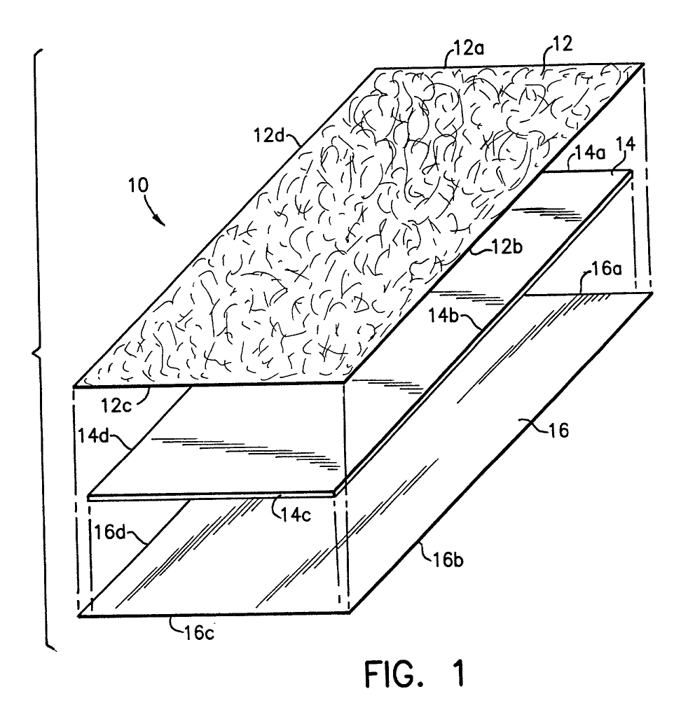

The absorbent pad is generally identified in FIGS. 1 - 3 by the numeral 10 with upper film layer 12, lower film layer 16 and intermediate absorbent layer 14. As illustrated in the drawings, absorbent pad 10 may be of rectangular shape, although any geometric shape may be used, so as to be positioned or supported by commonly rectangularity-shaped containers used for the preparation of food. When the upper film layer 12, lower film layer 16 and intermediate absorbent layer 14 are assembled to one another, at least two of the four marginal edge portions 12a, 12b, 12c and 12d of the upper film layer 12 and the four marginal edges of 16a, 16b, 16c and 16d of lower film layer 16 are attached to one another, through the use of mechanical sealing means, hear sealing means and/or by adhesive sealing means (e.g., glue or binding polymers) to attach and seal the upper film layer 12 and lower film layer 16 and intermediate absorbent layer 14, having marginal edges 14a, 14b, 14c and 14d, as such are assembled to one another to form the absorbent pad. The marginal edge of the upper film layer and lower film layer are preferably attached to one another, through the use of heat and/or pressure, to attach and seal at least one of the two pairs of opposing marginal edge portions of upper film layer 12 and lower film layer 16 to one another, as best seen in FIG. 2 of the drawings. For some absorbent pad uses, it may be preferable to seal only two of the opposing marginal edge portions of the upper film layer and lower film layer of absorbent pad 10. In lieu of thermal and/or mechanical sealing, hot melts or cold adhesives, binding fibers or adhesive pressure or heat activated powders added to the absorbent as well as traditional glues may be used to seal the marginal edge portions of the upper film layer 12 and lower film layer 16. The upper film layer 12 and lower film layer 16 may both be made from high temperature resistant polymeric materials, such as polyester materials whereby both film layers 12 and 16 are heat resistant, so the absorbent pad can be used in microwave and conventional cooking, as well as be heat resistant to hot liquids excreted from hot foods.

For sealing the marginal edges of upper film layer 12 and lower film layer 16 to one another along at least two opposing marginal edge portions, the use of heat and pressure to seal and bond marginal edge portions and to form optional cross batch seal designs on upper and lower film layers is preferred owing to its ease of use in manufacturing. Again, hot melt or cold adhesives may also be employed. All materials used to form the instant absorbent pads will be selected to be suitable for food contact if food contact is the intended use of the instant absorbent pads.

Attention is now directed to the intermediate absorbent layer 14 shown in FIG. 1 of the drawings. The intermediate absorbent layer may be constructed from man made or natural fibers or a combination thereof, either woven or non-woven, which are secured or attached to one another. Preferably, the absorbent material fibers of the absorbent pad are formed from cellulose and/or thermoplastic fibers that are non-woven and attached to one another. Preferably, the cellulose and thermoplastic fibers are juxtaposed and overlapped or superimposed relative to one another and compressed sufficiently to maintain their relative consistency or integrity during manufacturing operations. The absorbent material fibers may be secured to one another as a plurality of intertwined structurally supported fibers having spaced interstices therebetween to facilitate absorbency for liquids. The preferred absorbent material is a cellulosic-based material, such as cellulosic absorbents having absorbent wood pulp and/or paper fibers. The absorbent is selected to provide a desired amount of absorbency related to the intended use of the absorbent pad. For use in cooking and other consumer use the absorbency of the absorbent pad is typically between about 4 grams and about 20 grams of liquid per gram of absorbent material.

The upper film layer is characterized as being porous by perforation slits or other pore openings to permit wicking through upper film layer 12 of absorbent pad 10. These pore openings are of a size to provide for liquid transfer to and retention by the intermediate absorbent layer of absorbent pad 10. This enables liquids or fluids to enter the intermediate absorbent layer 14 through wicking or capillary action and be absorbed by the absorbent material. Spunbonded, polyester materials (such as that available from Freudenberg Spunweb Company under its Lutradur® trademark and from Reemay, Inc. under its Reeyman® trademark) are suitable for use as the upper film layer as well as other non-porous polyester materials which have been perforated or slit to provide a porous structure for the upper film layer. The upper film layer is characterized as being temperature resistant, porous and having capacity to let liquids of many types pass through the porous structure. Typically, spunbonded, non-woven porous polyesters have a melting point above 150 degrees centigrade, (preferably above 210 degrees centigrade), a web density between about 0.2 ounces per square yard and about 5 ounces per square yard and an overall chemical resistance to the liquids to be absorbed by the adsorbent pad. The lower film layer is preferably a non-porous polyester having thermal resistance to melting equal to or greater than that of the upper film layer and having a thickness of between about 0.2 mil and about 5 mils. A polyester film suitable for use in the instant absorbent pad is MYLAR® LB. available from DuPont Company. This polyester film can be coextruded or coated with a sealing layer (such as LDPE, LLDPE, EVA, ionomer, acid copolymer, amphorous polyester or other material used for adhesive or extrusion bonding techniques) for use in sealing to the upper film layer and/or the intermediate absorbent layer. An example of this type of a coextruded polyester film material is MELINEX 850H and 851H, available from ICI Americas, Inc. This polyester film is a coextruded, heat sealable polyester film having both an amorphous and a crystalline polyester layer. The amorphous polyester layer provides a heat sealable layer for use in heat sealing the lower film layer to the upper film layer and/or the intermediate absorbent layer and can be heat sealed to a spunbonded polyester.

The method of constructing absorbent pad 10 can be continuous or discontinuous. The manufacturing steps may include forming an upper film layer and lower film layer, with the upper film layer being perforated to provide its porosity. The intermediate absorbent material layer 14 may be formed from a single material or from a number of absorbent materials or as a non-woven web with spaced interstices therein, as described above The manner of forming the intermediate absorbent material layer 14 has been discussed above. The absorbent material layer 14 is then positioned between the upper film layer 12 and lower film layer 16 as shown in FIGS. 1 and 2 of the drawings, and the layers are moved into assembled proximity to one another, to allow for marginal edges of the upper film layer and lower film layer to be sealed at least partially along two opposing marginal edges thereof to be attached, for retaining the absorbent layer 14 therebetween. The layers 12, 14 and 16 may be formed into an elongated strip containing multiple absorbent pads which are provided with a series of perforations extending transversely across the strip to enable individual absorbent pads to be formed. Alternatively, a strip of absorbent pad can be cut from a strip of absorbent pad. Alternatively, individual absorbent pads can be formed from a larger sheet from which several absorbent pads are cut by means of a stamping die operation which forms individual pads and, optionally, also forms at least two heat seals along marginal edges. The upper film layer 12 and lower film layer 16 can be attached to one another along opposing marginal edge portions at seal 19 during either of such assembly processes, and formed into discrete absorbent pads. Each absorbent pad may be provided with up to four sealed marginal edges 18a, 18b, 18c and 18d as shown in FIG. 1, and may also be additionally sealed transversely and/or longitudinally to provide four marginal edge seals 19 as shown in FIG. 2 of the drawings and cross hatch seals (not shown).

The instant invention also relates to a method of cooking wherein the absorbent pads of this invention are used in microwave cooking by: placing a food to be cooked under effective microwave cooking conditions in a microwave oven on at least one absorbent pad according to this invention; cooking the food such that at least a portion of the liquids formed from the food during microwave cooking are absorbed by the absorbent pad: and then removing said food from the absorbent pad. A variation on the above method of cooking involves the use of two or more stacked absorbent pads where food is placed between absorbent pads placed preferably with the upper film layer of one pad facing the lower film layer of another absorbent pad rather than having two upper film layers in opposition with food between them. It has been found that use of five stacked absorbent pads with bacon placed between each upper film layer of one pad and the lower film layer of another pad is effective for microwave cooking a quantity of bacon too large for a single absorbent pad. In one embodiment two or more absorbent pads are stacked in the aforementioned fashion with a food such as bacon, sausage or other meat there between.

While the instant invention has been described as to specific embodiments above, one skilled in the art will recognize the various modifications and variants to the above teachings. The instant claims as intended to cover such variants and modifications.

In the claims:

1. An absorbent pad for absorbing liquid or the like comprising:
a. an upper film layer of a heat resistant, thermoplastic porous material having outside and inside surfaces and four peripheral edges;
b. a lower film layer of a heat resistant, non-porous thermoplastic material having four peripheral edges, the lower film layer having outside and inside surfaces and being bonded to the top layer along at least two of their respective opposing four peripheral edges; and
c. an intermediate absorbent layer of liquid absorbent material between the upper film layer and lower film layer having peripheral edges and having said intermediate absorbent layer at least partially bonded to the inside surface of at least one of said upper film layer or said lower film layer.

2. An absorbent pad according to claim 1 wherein peripheral edges of said intermediate absorbent layer are recessed from said seals at said peripheral edges of said lower film layer and upper film layer.

3. An absorbent pad according to claim 2 wherein:
(i) the intermediate absorbent layer is made from paper or a non-woven synthetic material;
(ii) the upper film layer is made from a porous spunbonded polyester: and
(iii) the lower film layer is made from a non-porous polyester film.

4. An absorbent pad according to claim 1 wherein all opposing peripheral edges of said upper film layer and lower film layer are sealed.

5. An absorbent pad according to claim 4 wherein said upper film layer and said lower film layer are heat sealed.

6. An absorbent pad according to claim 3 wherein:
(i) said upper film layer and said lower film layer are formed from heat resistant polyester materials suitable for microwave cooking having a melting point of at least 150 degree Celsius; and
(ii) said center layer is a cellulosic-based material having an absorbency for water of at least 10 grams of water per gram of cellulosic-based material and an absorbency for corn oil of at least 9 grams of corn oil per gram of cellulosic-based material.

7. An absorbent pad according to claim 6 wherein said absorbency for water of said cellulosic material is a paper made from wood pulp.

8. An absorbent pad according to claim 1 wherein:
(a) said upper film layer is a porous spunbonded polyester having an absorbency for water and corn oil less than the intermediate absorbent layer;
(b) said lower film layer is a non-porous polyester characterized as having a first crystalline polyester outer layer and a second amorphous polyester inner layer; and
(c) said intermediate absorbent layer is selected from the group consisting of wood pulp and cellulosic-based papers.

9. An absorbent pad according to claim 8 wherein said upper film layer and lower film layer are joined at the peripheral edges by thermally sealing said first crystalline polyester layer to said upper film layer with said amorphous polyester layer therebetween.

10. An absorbent pad according to claim 6 wherein all opposing peripheral edges of the upper film layer and lower film layer are heat sealed to each other and said peripheral edges of said intermediate absorbent layer are recessed from said sealed opposing peripheral edges.

11. An absorbent pad according to claim 1 wherein said lower film layer is at least partially bonded to said intermediate absorbent layer.

12. A method of making an absorbent pad comprising the steps of:
(i) providing a center layer of absorbent material between a porous upper film layer and non-porous lower film layer, each layer having peripheral edges, said edges of said intermediate absorbent layer being recessed from said edges of said upper film layer and said lower film layer;
(ii) bonding at least a portion of said lower film layer to said intermediate absorbent layer; and
(iii) bonding at least two of said opposing edges of said upper film layer and said lower film layer.

13. A method for microwave cooking comprising the steps of:
(i) placing a food to be cooked under effective microwave cooking conditions in a microwave oven on at least one absorbent pad according to claim 1;
(ii) cooking said food under effective microwave cooking conditions such that at least a portion of the liquids formed from the food during microwave cooking are absorbed by said absorbent pad; and
(iii) removing said food from said absorbent pad.

14. A method for microwave cooking according to claim 13 wherein said food is placed between at least two absorbent pads having said upper film layer of a first absorbent pad opposing the lower film layer of a second absorbent dad.
